(19) United States
(12) Patent Application Publication
(10) Pub. No.: US 2022/0035291 A1
(43) Pub. Date: Feb. 3, 2022

(54) INFORMATION PROCESSING APPARATUS AND SYSTEM

(71) Applicant: TOSHIBA TEC KABUSHIKI KAISHA, Tokyo (JP)

(72) Inventor: Kazuhiko KIKUCHI, Yokohama Kanagawa (JP)

(21) Appl. No.: 17/319,521

(22) Filed: May 13, 2021

(30) Foreign Application Priority Data
Aug. 3, 2020 (JP) 2020-131495

(51) Int. Cl. G03G 15/00

(52) U.S. Cl. CPC G03G 15/55

(57) ABSTRACT

According to one embodiment, the information processing apparatus includes an acquisition unit, a derivation unit, and a determination unit. The acquisition unit acquires voltage information indicating a voltage applied to a heat generation unit that heats a sheet in an image forming apparatus. The derivation unit derives a fluctuation range in the voltage indicated by the voltage information acquired by the acquisition unit. The determination unit determines whether or not there is an indication of a malfunction in the heat generation unit using the fluctuation range derived by the derivation unit and a reference fluctuation range.

### CROSS-REFERENCE TO RELATED APPLICATION

This application is based upon and claims the benefit of priority from Japanese Patent Application No. 2020-131495, filed Aug. 3, 2020, the entire contents of which are incorporated herein by reference.

### FIELD

Embodiments described herein relate generally to an information processing apparatus and an information processing system incorporating an information process apparatus.

### BACKGROUND

An image forming apparatus includes a fixing device for fixing toner. The fixing device includes a heating element. As the heating element, a resistor may be used. In such a case in the related art, an indication of a malfunction of the heating element may be detected by detecting a change in resistance of the resistor. However, it is generally difficult to determine whether or not there is a malfunction in the heating element on the basis of the change in resistance.

### BRIEF DESCRIPTION OF THE DRAWINGS

FIG. 1 depicts aspects of an information processing system.

FIG. 2 depicts aspects of a server.

FIG. 3 depicts a schematic configuration of an image forming apparatus.

FIG. 4 depicts aspects of a hardware configuration of an image forming apparatus.

FIG. 5 is a cross-sectional view illustrating a heating device.

FIG. 6 is a cross-sectional view illustrating a heater unit.

FIG. 7 is a bottom view illustrating a heater unit.

FIG. 8 is a plan view illustrating aspects of a heater thermometer and a thermostat.

FIG. 9 depicts electrical aspects of a heating device.

FIG. 10 is graph depicting an experimental result showing a relationship between an elapsed time from a power supply startup and a temperature of a cylindrical film.

FIG. 11 depicts an example of a fluctuation in a voltage applied to a heating element group when the heating element group is new.

FIG. 12 depicts an example of a fluctuation in a voltage applied to a heating element group indicating a malfunction.

FIG. 13 is a sequence diagram illustrating a process relating to reference voltage information.

FIG. 14 is a sequence diagram illustrating a process relating to operating voltage information.

FIG. 15 is a flowchart illustrating a determination process by a determination unit.

### DETAILED DESCRIPTION

Embodiments provide an information processing apparatus and an information processing system, which more accurately determine whether there is an indication of a malfunction in a heating device.

In general, according to one embodiment, the information processing apparatus includes an acquisition unit, a derivation unit, and a determination unit. The acquisition unit is configured to acquire voltage information indicating a voltage applied to a heat generation unit that heats a sheet in an image forming apparatus. The derivation unit is configured to derive a fluctuation range in voltage indicated by the voltage information acquired by the acquisition unit. The determination unit is configured to determine whether or not there is an indication of a malfunction in the heat generation unit using the fluctuation range derived by the derivation unit and a reference fluctuation range.

According to an embodiment, an information processing apparatus and an information processing system can be provided in which malfunctions in a heating device can be more accurately determined. Hereinafter, an information processing apparatus and a system according to certain example embodiments will be described.

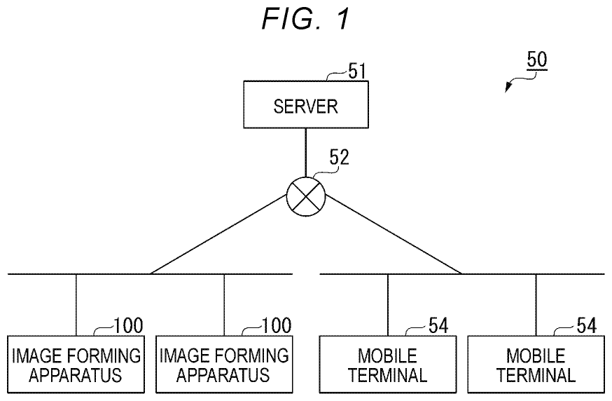

FIG. 1 is a diagram illustrating a configuration example of a system 50 including an image forming apparatus 100 and a server 51. The system 50 can have one or more image forming apparatuses 100, one or more mobile terminals 54, and at least one server 51. The image forming apparatuses 100, the mobile terminals 54, and the server 51 are connected to a network 52. The network 52 can be a network such as the Internet. Each image forming apparatus 100 stores voltage information that indicates the voltage applied to a heat generation unit within the image forming apparatus 100 that heats a sheet as part of the image forming process or the like. The image forming apparatus 100 transmits the stored voltage information to the server 51. Additional details of the voltage information will be described below.

The server 51 is an example of the information processing apparatus and includes an arithmetic device (e.g., a processor), a storage device, and the like. The server 51 acquires the voltage information transmitted from the image forming apparatus 100. The server 51 then derives a voltage fluctuation range from the acquired voltage information. The server 51 sends (“notifies”) a warning that there is a malfunction (or possible malfunction) based on the derived fluctuation range and a reference fluctuation range. The destination for the warning notification can be the image forming apparatus 100 providing the voltage information or a mobile terminal 54 associated with the image forming apparatus 100 that has provided the voltage information. In this context, the mobile terminal 54 can be a terminal carried by a service person who executes maintenance on the image forming apparatus 100.

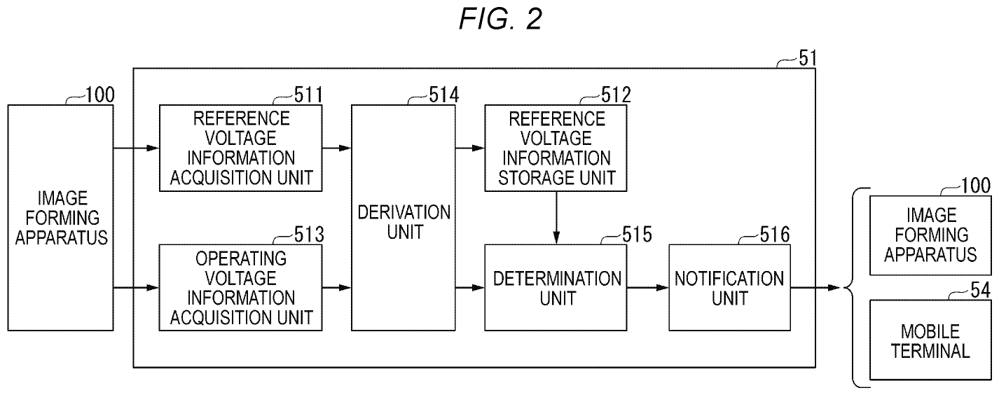

FIG. 2 is a diagram illustrating a configuration of the server 51. The server 51 as configured by software or the like includes a reference voltage information acquisition unit 511, a reference voltage information storage unit 512, an operating voltage information acquisition unit 513, a derivation unit 514, a determination unit 515, and a notification unit 516.

The image forming apparatus 100 transmits two kinds of voltage information including reference voltage information and operating voltage information to the server 51. In this context, the reference voltage information indicates voltages detected when the image forming apparatus 100 was in a new condition, for example, before factory shipment or at the time of installation. The operating voltage information indicates voltages detected when the image forming apparatus 100 is actually operating (that is, operations at some point after the initial “new condition” state).

First, the server 51 acquires the reference voltage information via the reference voltage information acquisition unit 511. The reference voltage information acquisition unit 511 outputs reference voltage information to the derivation unit 514. The derivation unit 514 then derives a reference voltage and a reference fluctuation range from the reference voltage information, and stores the derived reference voltage and reference fluctuation range in the reference voltage information storage unit 512. The derived reference voltage and reference fluctuation range is subsequently used by the determination unit 515.

The operating voltage information acquisition unit 513 acquires the operating voltage information and supplies the acquired operating voltage information to the derivation unit 514. The derivation unit 514 derives an operating voltage and an operating fluctuation range from the operating voltage information, and outputs the derived operating voltage and operating fluctuation range to the determination unit 515. The determination unit 515 determines whether there is an indication of a malfunction using the operating voltage and the operating fluctuation range and the reference fluctuation range and the reference voltage. The determination unit 515 outputs a determination result to the notification unit 516. The determination result is output in this example as “OK” (good) or “NG” (not good). In this context, “OK” indicates that there is no indication of a malfunction and “NG” indicates that there is an indication of a malfunction.

When the determination result is NG, the notification unit 516 notifies the image forming apparatus 100 or the mobile terminal 54 with a warning indicating that there is an indication of a malfunction. Whether the notification destination for such a warning is the image forming apparatus 100, the mobile terminal 54, or both the image forming apparatus 100 and the mobile terminal 54 can set by a user, a service person, or the like in advance.

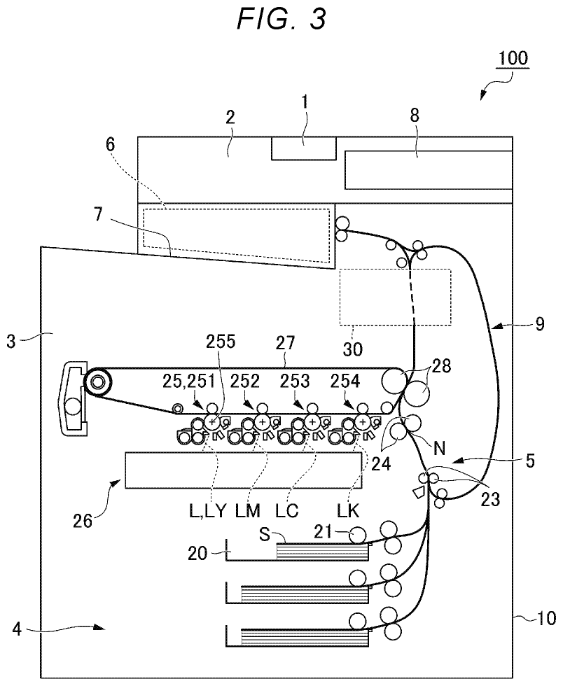

FIG. 3 is a diagram illustrating a schematic configuration of the image forming apparatus 100 according to an embodiment. The image forming apparatus 100 is, for example, a multi-functional peripheral (MFP). The image forming apparatus 100 includes a housing 10, a display 1, a scanner unit 2, an image forming unit 3, a sheet supply unit 4, a conveyance unit 5, a sheet discharge tray 7, a reversing unit 9, a control panel 8, and a control unit 6.

The image forming apparatus 100 forms an image on a sheet S using a developer such as toner. The sheet S is, for example, paper or label paper. In general, the sheet S may be any material as long as the image forming apparatus 100 can form an image on a surface thereof.

The housing 10 forms an external shape of the image forming apparatus 100. The display 1 is an image display device such as a liquid crystal display or an organic EL (Electro Luminescence) display. The display 1 displays various information relating to the image forming apparatus 100.

The scanner unit 2 reads image information of a reading target based on brightness and darkness of light. The scanner unit 2 records the read image information. The scanner unit 2 outputs the generated image information to the image forming unit 3. The recorded image information may also or instead be transmitted to another information processing apparatus through a network.

The image forming unit 3 forms an image (hereinafter, referred to as a “toner image”) with a recording agent such as toner based on the image information received from the scanner unit 2 or otherwise image information received from the outside of the image forming apparatus. The image forming unit 3 transfers the toner image to a surface of the sheet S. The image forming unit 3 applies heat and pressure to the toner image on the surface of the sheet S such that the toner image is fixed to the sheet S. The sheet S may be a sheet supplied by the sheet supply unit 4 or a sheet that is manually fed.

The sheet supply unit 4 supplies the sheet S to the conveyance unit 5 one by one at a timing corresponding to that at which the image forming unit 3 forms the toner image. The sheet supply unit 4 includes a sheet accommodation unit 20 and a pickup roller 21.

The sheet accommodation unit 20 accommodates the sheets S having predetermined sizes and predetermined types. The pickup roller 21 picks up the sheets S from the sheet accommodation unit 20 one by one. The pickup roller 21 supplies the picked-up sheet S to the conveyance unit 5.

The conveyance unit 5 conveys the sheet S from the sheet supply unit 4 to the image forming unit 3. The conveying unit 5 includes conveyance rollers 23 and registration rollers 24. The conveyance rollers 23 convey the sheet S from the pickup roller 21 to the registration rollers 24. The conveyance rollers 23 allow a tip of the sheet S in a conveying direction to abut against a nip N of the registration rollers 24.

The registration rollers 24 align a position of the tip of the sheet S in the conveying direction by bending the sheet S at the nip N. The registration rollers 24 convey the sheet S to match a timing at which the image forming unit 3 can appropriately transfer the toner image to the sheet S.

The image forming unit 3 includes a plurality of image forming units 25, a laser scanning unit 26, an intermediate transfer belt 27, a transfer unit 28, and a fixing device 30. The image forming unit 25 includes a photoconductive drum 255. The image forming unit 25 forms a toner image on the photoconductive drum 255 based on the image information received from the scanner unit 2 or the outside. Individual image forming units 251, 252, 253, and 254 of the plurality of image forming units 25 form toner images with yellow, magenta, cyan, and black toners, respectively.

An electrostatic charging unit, a developing unit, and the like are arranged around the photoconductive drum 255. The electrostatic charging unit charges a surface of the photoconductive drum 255. The developing unit stores a developer containing one of the yellow, magenta, cyan, and black toners. The developing unit develops an electrostatic latent image that has been formed on the photoconductive drum 255 by selective exposure.

The laser scanning unit 26 scans the charged photoconductive drums 255 with laser light L to selectively expose each photoconductive drum 255. The laser scanning unit 26 exposes the photoconductive drums 255 of the image forming units 251, 252, 253, and 254 to laser light LY, LM, LC, and LK, respectively. As a result, the laser scanning unit 26 forms the electrostatic latent images on the photoconductive drums 255 according to corresponding color.

The toner image on the surface of each photoconductive drum 255 is then transferred to the intermediate transfer belt 27 (referred to as primary transfer). The transfer unit 28 transfers the toner image from the intermediate transfer belt 27 to the surface of the sheet S at a secondary transfer position. The fixing device 30 applies heat and pressure to the toner image on the sheet S to fix the toner image to the sheet S.

The reversing unit 9 operates to invert the sheet S for forming an image on the back surface of the sheet S when double-sided printing is instructed. The reversing unit 9 switches back the sheet S discharged from the fixing device 30 to invert front and back surfaces of the sheet S. The reversing unit 9 conveys the inverted sheet S to the registration rollers 24.

The sheet discharge tray 7 holds the discharged sheet S on which the image has been formed. The control panel 8 includes a plurality of buttons. The control panel 8 receives the input operations of a user. The control panel 8 outputs a signal corresponding to the operation input by the user to a control unit 6 of the image forming apparatus 100. The display 1 and the control panel 8 may be integrally configured as a touch panel. The control unit 6 controls the individual units of the image forming apparatus 100.

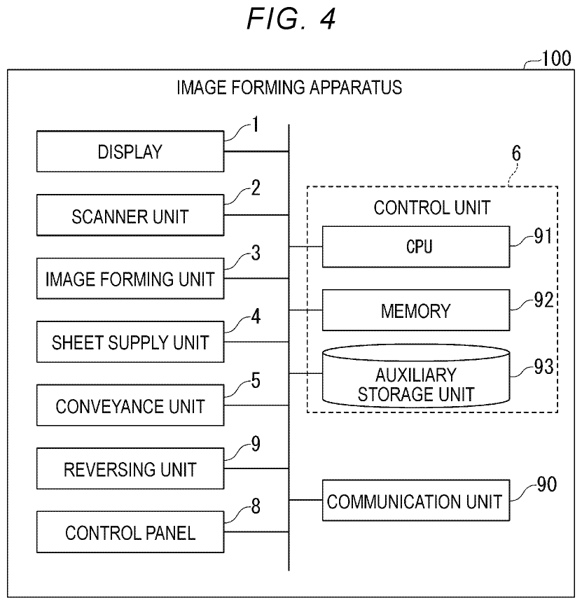

FIG. 4 is a diagram illustrating a specific example of a hardware configuration of the image forming apparatus 100 according to an embodiment. The image forming apparatus 100 includes a central processing unit (CPU) 91, a memory 92, an auxiliary storage device 93, which are connected via a bus. The image forming apparatus 100 (more particularly, CPU 91 therein) executes a program. By executing the program, the image forming apparatus 100 provides the various described functions of a scanner unit 2, an image forming unit 3, a sheet supply unit 4, a conveyance unit 5, a reversing unit 9, a control panel 8, and a communication unit 90. In some examples, some or all of the individual described functions of the image forming apparatus 100 may be implemented in hardware such as an application integrated circuit (ASIC), a programmable logic device (PLD) , or a field programmable gate array (FPGA). The program may be recorded in a non-transitory computer-readable recording medium. The computer-readable recording medium can be a storage device, a portable medium such as a flexible disk, a magneto-optical disk, a ROM, or a CD-ROM or a hard disk built into a computer system. The program may be transmitted, downloaded, or accessed via an electronic telecommunication line, communication network, or the like.

By executing programs stored in the memory 92 and the auxiliary storage device 93, the CPU 91 provides the various described functions of the control unit 6. The control unit 6 controls operations of the image forming apparatus 100. The auxiliary storage device 93 comprises a storage device such as a magnetic hard disk device, a semiconductor memory device, a solid-state memory device, or the like. The auxiliary storage device 93 stores various information relating to the image forming apparatus 100. The communication unit 90 includes a communication interface for connecting to an external device or network. The communication unit 90 communicates with external devices via the communication interface.

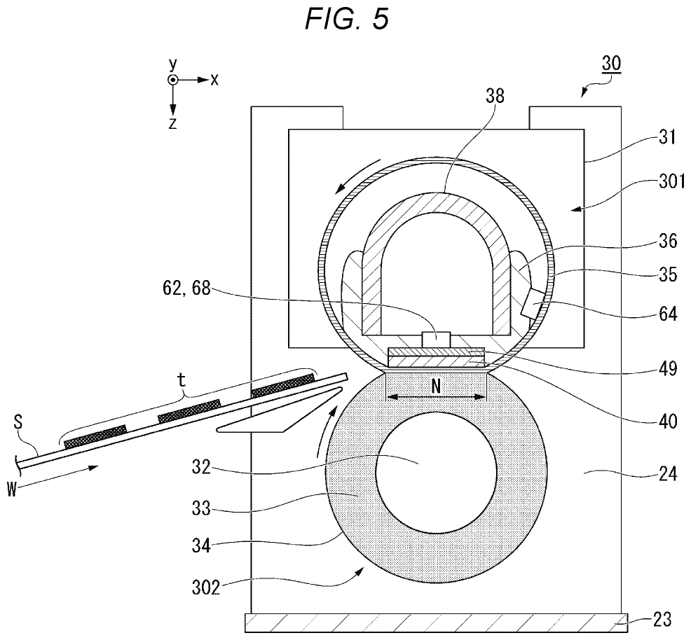

FIG. 5 is a diagram illustrating the fixing device 30. The fixing device 30 includes a press roller 302 and a fixing unit 301.

A nip N is formed between the press roller 302 and the fixing unit 301. The press roller 302 presses the toner image t of the sheet S at the nip N. The press roller 302 rotates and conveys the sheet S through the nip N. The press roller 302 includes a core metal 32, an elastic layer 33, and a release layer 34. The press roller 302 can press the surface against a fixing film 35 and still be rotatable.

The core metal 32 is formed of a metal material such as stainless steel in a cylindrical shape. Both end portions of the core metal 32 in an axial direction are rotatably supported. The core metal 32 is rotated by a motor. The core metal 32 abuts against a cam member. The cam member rotates to move the core metal 32 closer to or away from the fixing unit 301.

The elastic layer 33 is formed of an elastic material such as a silicone rubber. The elastic layer 33 is formed on an outer circumferential surface of the core metal 32 with a constant thickness. The release layer 34 is formed of a resin material such as a tetrafluoroethylene-perfluoroalkyl vinyl ether copolymer (PFA). The release layer is formed on an outer circumferential surface of the elastic layer 33. It is desirable that the hardness of the outer circumferential surface of the press roller 302 is 40° to 70° when measured with an ASKER-C hardness tester under a load of 9.8 N (newtons). As a result, the area of the nip N and the durability of the press roller 302 are secured. In the present embodiment, the hardness is 60°.

The press roller 302 can move closer to and away from the fixing unit 301 by the rotation of the cam member. When press roller 302 moves close to the fixing unit 301 and is pressed by a pressurization spring, the nip N is formed. On the other hand, when a sheet S is jammed in the fixing device 30, the sheet S can be removed by moving the press roller 302 away from the fixing unit 301. In addition, by moving the press roller 302 away from the fixing unit 301 when the rotation of the fixing film 35 will be stopped for a prolonged periods, for example, during a device sleep state or idle mode, plastic deformation of the fixing film 35 can be prevented.

The press roller 302 is rotated by a motor. When the press roller 302 rotates with the nip N formed, the fixing film 35 of the fixing unit 301 is also rotated by the press roller 302. When the press roller 302 rotates while a sheet S is in the nip N, the press roller 302 functions to convey the sheet S in the conveying direction W pass the nip N.

The fixing unit 301 heats the toner image t of the sheet S in the nip N. The fixing unit 301 includes the fixing film 35, a heater unit 40, a heat conduction member 49, a support member 36, a stay 38, a heater thermometer 62, a thermostat 68, and a film thermometer 64.

The fixing film 35 is formed in a cylindrical shape. The fixing film 35 includes a base layer, an elastic layer, and a release layer in order from the inner circumferential side. The elastic layer is laminated on an outer circumferential surface of the base layer. The elastic layer is formed of an elastic material such as a silicone rubber. The release layer is laminated on an outer circumferential surface of the elastic layer. The release layer is formed of a material such as a PFA resin.

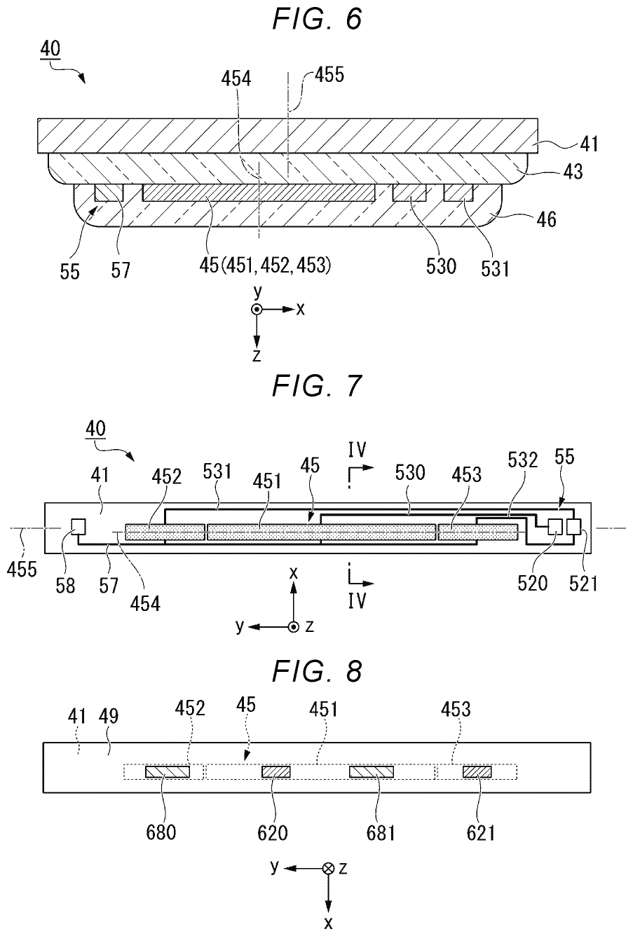

FIG. 6 is a front cross-sectional view of the heater unit taken along line IV-IV in FIG. 7. FIG. 7 is a bottom view (view when seen from a +Z direction) of the heater unit. The heater unit 40 includes a substrate (heating element substrate) 41, a heating element group 45, and a wiring group 55. The heating element group 45 is an example of the heat generation unit.

The substrate 41 is formed of, for example, a metal material such as stainless steel or a ceramic material such as aluminum nitride. The substrate 41 is formed of an elongated rectangular plate shape. The substrate 41 is arranged inside the fixing film 35 in a radial direction. An axial direction of the fixing film 35 is a longitudinal direction of the substrate 41.

For the description of the present example embodiment, an x direction, a y direction, and a z direction are defined as follows. The y direction is the longitudinal direction of the substrate 41. The y direction is also parallel to a width direction of the fixing film 35. The +y direction is a direction from a center heating element 451 toward a first end heating element 452. The x direction is a short (width) direction of the substrate 41, and the +x direction corresponds to the conveying direction of the sheet S (direction toward the downstream side). The z direction is a direction normal to the substrate 41, and the +z direction is the direction in which the heating element group 45 is arranged relative to the substrate 41. An insulating layer 43 is formed of a glass material or the like on a +z direction surface of the substrate 41.

The heating element group 45 is arranged on the substrate 41. As illustrated in FIG. 6, the heating element group 45 is formed on a +z direction surface of the insulating layer 43. The heating element group 45 is formed of a temperature coefficient of resistance (“TCR”) material for which electrical resistance varies with temperature change. For example, the heating element group 45 is formed of a silver-palladium alloy or the like. The external shape of the heating element group 45 is formed in a rectangular shape in which the longitudinal direction is the y direction and the width direction is the x direction.

As illustrated in FIG. 7, the heating element group 45 includes the first end heating element 452, the center heating element 451, and a second end heating element 453. The center heating element 451 is in the middle of the heating element group 45 in the y direction. In some examples, the center heating element 451 may comprise a plurality of smaller heating elements arranged along the y direction rather a single, unitary heating element. The first end heating element 452 is arranged at the +y direction end of the center heating element 451 and thus on the +y direction end of the heating element group 45. The second end heating element 453 is arranged at the −y direction end of the center heating element 451 and thus on the −y direction end of the heating element group 45. The boundary line between the center heating element 451 and the first end heating element 452 may be parallel to the x direction or may intersect the x direction. The same applies the boundary line between the center heating element 451 and the second end heating element 453.

The heating element group 45 generates heat when supplied with electric power (“energized”). The electrical resistance value of the center heating element 451 is lower than electrical resistance value of the first end heating element 452 and the electrical resistance value of the second end heating element 453. The ratio between the resistance values of the center heating element 451 and the first end heating element 452 may be in a range of 1:3 to 1:7 and is preferably in a range of 1:4 to 1:6. The ratio between the resistance values of the center heating element 451 and the second end heating element 453 may be in a range of 1:3 to 1:7 and is preferably in a range of 1:4 to 1:6.

A sheet S having a relatively small width in the y direction can pass through just the center portion of the fixing device 30. In this case, the control unit 6 causes only the center heating element 451 to generate heat. On the other hand, in the case of the sheet S having a larger width in the y direction, the control unit 6 causes the entire heating element group 45 to generate heat. Therefore, the center heating element 451 can be controlled to generate heat independently from the first end heating element 452 and the second end heating element 453. In this example, the first end heating element 452 and the second end heating element 453 are controlled to generate heat in the same manner.

The wiring group 55 is formed of a metal material such as silver. The wiring group 55 includes a center contact 520, a center wiring 530, an end contact 521, a first end wiring 531, a second end wiring 532, a common contact 58, and a common wiring 57.

The center contact 520 is arranged on the −y direction side of the heating element group 45. The center wiring 530 is on the +x direction side of the heating element group 45. The center wiring 530 is connected to a +x direction end of the center heating element 451 and the center contact 520.

The end contact 521 is arranged to the −y direction side of the center contact 520. The first end wiring 531 is arranged to the +x direction side of the heating element group 45 and the center wiring 530. The first end wiring 531 is connected to the +x direction end of the first end heating element 452 and the +x direction end portion of the end contact 521. The second end wiring 532 is arranged to the +x direction side of the heating element group 45 and the −x direction side of the center wiring 530. The second end wiring 532 is connected to the +x direction end side of the second end heating element 453 and the −x direction end portion of the end contact 521.

The common contact 58 is arranged on the +y direction side of the heating element group 45. The common wiring 57 is arranged in the −x direction of the heating element group 45. The common wiring 57 is connected to −x direction end of the center heating element 451, the first end heating element 452, and the second end heating element 453 and also the common contact 58.

The second end wiring 532, the center wiring 530, and the first end wiring 531 are arranged on the +x direction side of the heating element group 45. On the other hand, only the common wiring 57 is arranged on the −x direction side of the heating element group 45. Therefore, a centerline 454 of the heating element group 45 is offset in the −x direction with respect to a centerline 455 of the substrate 41.

The centerline 454 (see FIG. 6) of the heating element group 45 (midpoint of the heating element group 45 along the x direction) is positioned to be on the straight line that would connect the center of the press roller 302 and the center of the fixing unit 301 (more particularly the center axis of the cylinder formed by fixing film 35). However, as depicting in FIG. 6, the centerline 455 of the substrate 41 is offset in the +x direction from the centerline 454. Consequently, since the substrate 41 extends in the +x direction width of the nip N, a sheet S passed through the nip N is more easily released from the fixing unit 301 than would otherwise be the case.

The entire heating element group 45 is positioned to be within the region of the nip N and arranged to be at centered at the nip N. As a result, a thermal distribution of the nip N becomes more uniform and the sheet S passing the nip N will be more uniformly heated.

As illustrated in FIG. 6, the heating element group 45 and the wiring group 55 are formed on the +z direction side of the insulating layer 43. A protective layer 46 is formed of a glass material or the like to cover the heating element group 45 and the wiring group 55. The protective layer 46 improves sliding properties (reduces friction) between the heater unit 40 and the fixing film 35.

As illustrated in FIG. 5, the heater unit 40 is arranged to be on an inner side of the fixing film 35. An inner circumferential surface of the fixing film 35 is typically coated with a lubricant. The heater unit 40 will be in contact with the inner circumferential surface of the fixing film 35 via the lubricant. However, when the heater unit 40 generates heat, the viscosity of the lubricant decreases with increased temperature. As a result, the sliding properties of the heater unit 40 and the fixing film 35 are improved. The fixing film 35 is a belt-like thin film that slides on the surface of the heater unit 40 while contacting the heater unit 40.

The heat conduction member 49 is formed of a metal material having a high thermal conductivity such as copper. In this example, the planar shape of the heat conduction member 49 matches the planar shape of the substrate 41. The heat conduction member 49 is contacts a surface of the heater unit 40 on the −z direction side. A surface of the heat conduction member 49 in contact with the heater unit 40 can be plated with nickel.

The support member 36 has stiffness, heat tolerance, and thermal insulating properties and can be formed of a resin material such as a liquid crystal polymer. The support member 36 is arranged to cover portions of the −z direction surface and both x direction edges of the heater unit 40. The support member 36 supports the heater unit 40 via the heat conduction member 49. Both x direction end portions of the support member 36 are rounded to support the inner circumferential surface of the fixing film 35 at both the x direction end portions of the heater unit 40.

When a sheet S passing through the fixing device 30 is heated, a temperature distribution in the heater unit 40 may vary according to the size of the sheet S. When the temperature of the heater unit 40 increases locally, the temperature may become higher than the heat-tolerance temperature of the support member 36 (which is formed of a resin material). The heat conduction member 49 serves to balance the temperature distribution across the heater unit 40. As a result, local temperatures do not easily overcome the heat tolerance of the support member 36.

The stay 38 illustrated in FIG. 5 is formed of a steel sheet material or the like. Across-section of the stay 38 perpendicular to the y direction has a U-shape. The stay 38 is mounted on the −z direction side of the support member 36 such that the opening portion of the U-shape is therefore closed by the support member 36. The stay 38 extends in the y direction. Both end portions of the stay 38 in the y direction can be fixed to the housing 10 of the image forming apparatus 100. As a result, the fixing unit 301 is supported by the image forming apparatus 100. The stay 38 improves (increases) rigidity of the fixing unit 301. Flanges 31 that restricts the movement of the fixing film 35 in the y direction are attached near both end portions of the stay 38.

The heater thermometer 62 is arranged on the −z direction side of the heater unit 40 via the heat conduction member 49. For example, the heater thermometer 62 is a thermistor. The heater thermometer 62 can be mounted and supported on the −z direction surface of the support member 36. A temperature sensitive element of the heater thermometer 62 can contact the heat conduction member 49 through a hole that penetrates the support member 36 in the z direction. The heater thermometer 62 measures a temperature of the heater unit 40 via the heat conduction member 49. In the heater thermometer 62, a thermistor element can be arranged via ceramic material or the like for stabilizing the contact of heater thermometer 62 to the heater unit 40. The heater thermometer 62 can also be covered with an insulating material such as a polyimide tape.

The thermostat 68 is disposed a similar manner as the heater thermometer 62. The thermostat 68 is incorporated into an electric circuit as explained further below. If the temperature of the heater unit 40 (as detected through the heat conduction member 49) exceeds a predetermined temperature, the thermostat 68 blocks power to the heating element group 45.

FIG. 8 is a plan view (a view from the −z direction) of the heater thermometer 62 and the thermostat 68. In FIG. 8, the support member 36 is omitted from the depiction. The following description relating to the arrangement and positioning of the heater thermometers 62, the thermostats 68, and the film thermometers 64 concerns more particularly the arrangement and position of the temperature sensitive elements thereof.

A plurality of heater thermometers 62 (more particularly in this example, a center heater thermometer 620 and an end heater thermometer 621) are arranged spaced from each other along the y direction. The heater thermometers 62 are arranged to be within the y direction range of the heating element group 45. In this context, being “within the y direction range” refers to an overlapping of y direction positions in a plan view. The heater thermometers 62 are also centered within the x direction width of the heating element group 45. That is, when seen from the z direction, at least a part of each of the heater thermometers 62 overlaps the heating element group 45. A plurality of thermostats 68 (more particularly in this example, a center thermostat 681 and an end thermostat 680) are similarly disposed as the heater thermometers 62.

The plurality of heater thermometers 62 includes the center heater thermometer 620 and the end heater thermometer 621. The center heater thermometer 620 measures the temperature of the center heating element 451. When seen from the z direction, the center heater thermometer 620 and the center heating element 451 overlap each other.

The end heater thermometer 621 measures the temperature of the second end heating element 453. In the present example, the first end heating element 452 and the second end heating element 453 are controlled to generate heat in the same manner. Therefore, the temperature of the first end heating element 452 and the temperature of the second end heating element 453 are considered to be the same. When seen from the z direction, the end heater thermometer 621 and the second end heating element 453 overlap each other.

The plurality of thermostats 68 includes the center thermostat 681 and the end thermostat 680. When the temperature of the center heating element 451 exceeds a predetermined temperature, the center thermostat 681 blocks power supply to the heating element group 45. When seen from the z direction, the center thermostat 681 and the center heating element 451 overlap each other.

When the temperature of the first end heating element 452 exceeds a predetermined temperature, the end thermostat 680 blocks power supply to the heating element group 45. As noted, the first end heating element 452 and the second end heating element 453 are controlled to generate heat in the same manner in this example. Therefore, the temperature of the first end heating element 452 and the temperature of the second end heating element 453 are considered to be the same. When seen from the z direction, the end thermostat 680 and the first end heating element 452 overlap each other.

The center heater thermometer 620 and the center thermostat 681 are arranged within the range of the center heating element 451. As a result, the temperature of the center heating element 451 is measured. If the temperature of the center heating element 451 exceeds a predetermined temperature, the power supply to the heating element group 45 is blocked. On the other hand, the end heater thermometer 621 and the end thermostat 680 are respectively arranged to overlap the first end heating element 452 and the second end heating element 453. As a result, the temperatures of the first end heating element 452 and the second end heating element 453 are measured. If the temperatures of the first end heating element 452 and the second end heating element 453 exceed a predetermined temperature, the power supply to the heating element group 45 is blocked.

The heater thermometers 62 and the thermostats 68 are alternately arranged with one another along the y direction. The first end heating element 452 is disposed on the +y direction side of the center heating element 451. The end thermostat 680 is arranged within the range of the first end heating element 452. The center heater thermometer 620 is disposed to the +y direction side of the center of the center heating element 451. The center thermostat 681 is positioned further in the −y direction with respect to the center of the center heating element 451. The second end heating element 453 is arranged on the −y direction side of the center heating element 451. The end heater thermometer 621 is positioned within the range of the second end heating element 453. The end thermostat 680, the center heater thermometer 620, the center thermostat 681, and the end heater thermometer 621 are arranged in this order from the +y direction end to the −y direction end.

In general, the thermostat 68 connects and disconnects an electric circuit by use of a bending deformation of bimetal (bimetallic) strip that changes according to the temperature. Thus, the thermostat 68 is usually formed in an elongated shape corresponding to the shape of the bimetal strip. In addition, a terminal extends outwardly from both end portions of the thermostat 68 in the longitudinal direction. An external wiring is connected to this terminal by solder, paste, or the like. Therefore, it is necessary to provide a space on the outside of the thermostat 68 in the longitudinal direction to permit wiring connection. Since there is typically very little, to no, spatial margin in the x direction of the fixing device 30, the longitudinal direction of the thermostat 68 is disposed to match the y direction. However, if the plurality of thermostats 68 are arranged closely adjacent to one another in the y direction, it will be difficult to provide a connection space necessary for an external wiring.

However, in the present embodiment, the heater thermometers 62 and thermostats 68 are alternately disposed with one another along the y direction. As a result, a heater thermometer 62 will be arranged adjacent to a thermostat 68 in the y direction.

Therefore, a connection space of an external wiring to the thermostat 68 can be provided. In addition, the degree of freedom for the layout of the thermostats 68 and the heater thermometers 62 in the y direction is higher. As a result, the thermostats 68 and the heater thermometers 62 can be arranged at optimum positions such that the temperature of the fixing device 30 can be better controlled. Furthermore, it is easier to separate alternating current (AC) wiring connected to the thermostat 68 from direct current (DC) wiring connected to the heater thermometers 62. As a result, the generation of noise in the electric circuit is suppressed.

As illustrated in FIG. 5, the film thermometer 64 is arranged inside the fixing film 35 and in the +x direction from the heater unit 40. The film thermometer 64 is in contact with an inner circumferential surface of the fixing film 35 and measures the temperature of the fixing film 35.

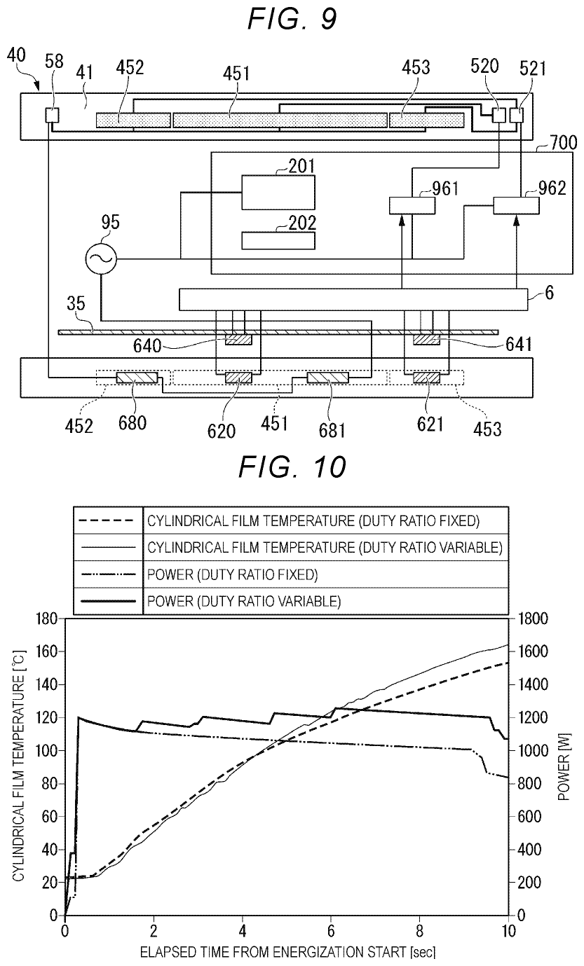

FIG. 9 is an electric circuit diagram illustrating the heating device according to an embodiment. In FIG. 9, the bottom view depicted in FIG. 7 is arranged on an upper part of the drawing, and the plan view depicted in FIG. 8 is arranged on a lower part of the drawing. In the middle part of FIG. 9, a cross-section of the fixing film 35 and a plurality of film thermometers 64 are illustrated. The plurality of film thermometers 64 includes a center film thermometer 640 and an end film thermometer 641. Further, in FIG. 9, a heater control substrate 700 is illustrated. The heater control substrate 700 may be, for example, a printed circuit board or the like.

The center film thermometer 640 is in contact with the center portion of the fixing film 35 in the y direction. The center film thermometer 640 is in contact with the fixing film 35 within the range in the y direction of the center heating element 451. The center film thermometer 640 measures the temperature of the center portion of the fixing film 35. The center film thermometer 640 converts the measured analog temperature value by analog-to-digital (AD) conversion and the outputs the measured temperature to the control unit 6 as a digital value.

The end film thermometer 641 is in contact with the −y direction end portion of the fixing film 35. The end film thermometer 641 is in contact with the fixing film 35 within the range in the y direction of the second end heating element 453. The end film thermometer 641 measures the temperature of the −y direction end portion of the fixing film 35. The end film thermometer 641 outputs the measured analog temperature after AD conversion to the control unit 6 as a digital value. As described above, the first end heating element 452 and the second end heating element 453 are controlled to generate heat in the same manner. Therefore, the temperature of the −y direction end portion of the fixing film 35 can be considered to be the same as the temperature of the +y direction end portion of the fixing film 35.

The heater control substrate 700 includes a power supply voltage detection circuit 201, a thermometer 202 for temperature compensation, a center triac 961, and an end triac 962. A power supply 95 supplies power to the heating element group 45. The power supply 95 is connected to the center contact 520 through the center triac 961. The power supply 95 is connected to the end contact 521 through the end triac 962. The power supply 95 is connected to the power supply voltage detection circuit 201. The thermometer 202 can be provided in the vicinity of an element having temperature dependent performance (for example, a coupler).

The control unit 6 controls ON and OFF of the center triac 961 and the end triac 962 independently from each other. When the control unit 6 turns the center triac 961 ON, power is supplied to the center heating element 451 from the power supply 95. As a result, the center heating element 451 generates heat. When the control unit 6 turns the end triac 962 ON, power is supplied to the first end heating element 452 and the second end heating element 453 from the power supply 95. As a result, the first end heating element 452 and the second end heating element 453 generate heat. As described above, the center heating element 451 is controlled independently from the first end heating element 452 and the second end heating element 453. The center heating element 451, the first end heating element 452, and the second end heating element 453 are connected in parallel to the power supply 95.

The power supply 95 is connected to the common contact 58 through the center thermostat 681 and the end thermostat 680. The center thermostat 681 and the end thermostat 680 are connected in series to each other. When the temperature of the center heating element 451 increases abnormally, the detected temperature of the center thermostat 681 will eventually exceed a predetermined threshold temperature. At this time, the center thermostat 681 cuts off power to the entire heating element group 45 from the power supply 95.

If the temperature of the first end heating element 452 increases abnormally, the detected temperature of the end thermostat 680 eventually exceeds a predetermined temperature. When this happens, the end thermostat 680 blocks power to the entire heating element group 45 from the power supply 95. As described above, the first end heating element 452 and the second end heating element 453 are controlled to generate heat in the same manner. Therefore, when the temperature of the second end heating element 453 increases abnormally, the temperature of the first end heating element 452 can be assumed to also increase abnormally. Accordingly, when the temperature of the second end heating element 453 increases abnormally, the end thermostat 680 also blocks power supply to the entire heating element group 45 from the power supply 95.

The temperature of the center heating element 451 is measured by the center heater thermometer 620, and this measured temperature is supplied to the control unit 6. The temperature of the second end heating element 453 is measured by the end heater thermometer 621, and this measured temperature is supplied to the control unit 6. The temperature of the second end heating element 453 is assumed to be the same as the temperature of the first end heating element 452. The temperature of the heating element group 45 is measured by the heater thermometer 62 when the fixing device 30 starts up (e.g., during a warm-up state upon turning on the device power supply or the like) and on returning from a paused state (e.g., a device sleep state or idle state) of the fixing device 30.

If the temperature of at least either the center heating element 451 or the second end heating element 453 is lower than some predetermined temperature when the fixing device 30 starts up and returns from the paused state, the control unit 6 causes the heating element group 45 to generates heat for a brief time. Next, after the brief heating if necessary, the control unit 6 starts rotation of the press roller 302. Due to the brief heat generation of the heating element group 45, the viscosity of the lubricant applied to the inner circumferential surface of the fixing film 35 decreases. As a result, the sliding properties of the heater unit 40 and the fixing film 35 at the start of rotation of the press roller 302 are improved.

The temperature of the center portion of the fixing film 35 is measured by the center film thermometer 640, and this measured temperature is supplied to the control unit 6. The temperature of the −y direction end portion of the fixing film 35 is measured by the end film thermometer 641, and this measured temperature is supplied to the control unit 6. The temperature of the −y direction end portion of the fixing film 35 in is assumed to be the same as the temperature of the +y direction end portion of the fixing film 35. The control unit 6 monitors the measured temperatures of the center portion and the end portion of the fixing film 35 when the fixing device 30 operates.

The control unit 6 can control a phase or a frequency of power to be supplied to the heating element group 45 using the center triac 961 and the end triac 962. The control unit 6 controls power supply to the center heating element 451 based on the temperature measurement result of the center portion of the fixing film 35. The control unit 6 controls power supply to the first end heating element 452 and the second end heating element 453 based on the temperature measurement results of a y direction end portion of the fixing film 35.

As described above, the heating element group 45 is formed of a TCR material having a resistance that increases with temperature. Therefore, when power supply to the heating element group 45 starts, the power utilized by the heating element group 45 gradually decreases with heating. In view of this issue, it would be conceivable to set initial electric power to be higher in anticipation of the dropping electric power resulting from the change in resistance of the TCR material. In general, an image forming apparatus is typically designed to utilize electric power up to ±10%, for example, of the expected commercial power supply in order to cope with fluctuations in the commercial power supply. If the initial power supply setting is set higher in this operating range, it is likely that the electric power setting will exceed an allowable range of a commercial power supply facility and, for example, a circuit breaker will cut off the power.

Furthermore, when higher electric power than a rated power is supplied to a TCR material, the change in resistance value can be large due to the additional heating. As a result, the amount of change in resistance value may exceed a design specification limit and the TCR material might fractured and a breakdown such as disconnection occurs. In view of these circumstances, the control unit 6 can gradually increase the power to be supplied to the heating element group 45 after the start of power supply. This gradual increase in power will be described further using FIG. 10.

FIG. 10 is a diagram illustrating an example of an experimental result representing a relationship between an elapsed time from the start of power supply and the temperature of the fixing film 35. The horizontal axis in FIG. 10 represents the elapsed time (in seconds) after the start of power supply to the heating element group 45. The left-side vertical axis in FIG. 10 represents the temperature (° C.) of the fixing film 35 and the right-side vertical axis represents supplied electric power (in watts (W)). The start of power supply in FIG. 10 is the time when the image forming apparatus 100 starts up or returns from a paused (idle) device state.

As illustrated in FIG. 10, if power is supplied to the heating element group 45 using a typical power supply method (that is, a power supply method in which the duty ratio is fixed), the power output decreases along with an increase in temperature of the TCR material. For example, as illustrated in FIG. 10, the power that is 1200 W immediately after power supply begins to decrease to about 1000 W after about 9 seconds after the start of power supply. The power decreases due to characteristics of the TCR material used in the heating element group 45. As a result, when power is supplied to the heating element group 45 using a typical power supply method, the rate of temperature increase for the fixing film 35 becomes slower with increased elapsed time after the start of power supply.

In contrast, as illustrated in FIG. 10, if power is supplied to the heating element group 45 using a different power supply method during start-up (that is, a power supply method in which the duty ratio is variable), the duty ratio can be changed to increase after a given period of time (in this experiment, 1.5 second intervals). As a result of the increased duty ratio, the power supplied to the heating element group 45 increases. In this experiment, the power supply to the heating element group 45 starts at a duty ratio of 80%, and then the duty ratio is changed four times to 85%, 90%, 95%, and 100% in stages at 1.5 second intervals.

Accordingly, as illustrated in FIG. 10, the power is increased four times during the startup/return period. As a result, a possible decrease in power is suppressed.

As illustrated in FIG. 10, the power can be maintained at about 1200 W for about 9 seconds after the start of power supply. In addition, the slowdown of the increase rate in temperature of the fixing film 35 over the elapsed time from the start of power supply is suppressed as compared to a typical power supply method.

Next, the fluctuation in the voltage applied to the heating element group 45 will be described. The relevant voltage in this context is the voltage as detected by the power supply voltage detection circuit 201.

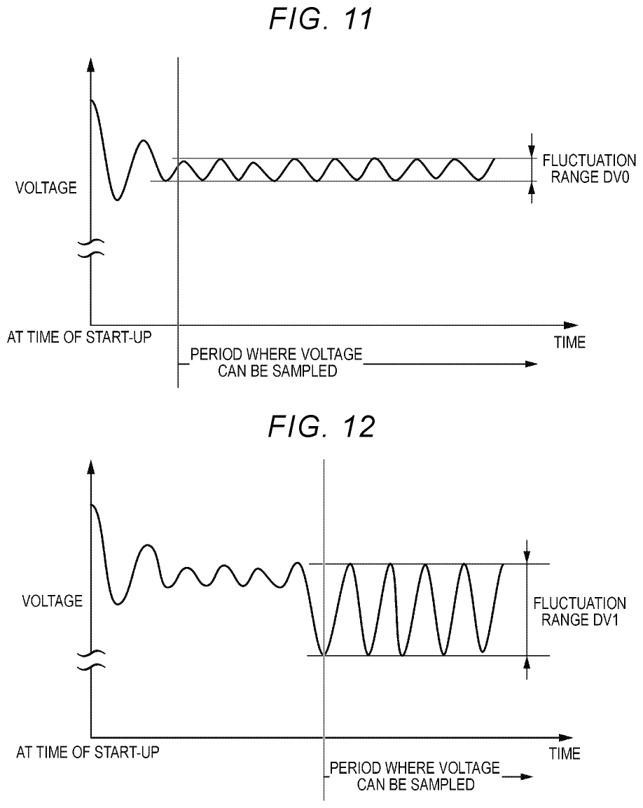

FIG. 11 is a diagram illustrating a fluctuation example of the voltage applied to the heating element group 45 at the start-up of the image forming apparatus 100 when the image forming apparatus 100 is new (hereinafter, also referred to as “in the new condition”).

FIG. 12 is a diagram illustrating a fluctuation example of the voltage applied to the heating element group 45 at the start-up of the image forming apparatus 100 when there is an indication of a malfunction in the heating element group 45 (hereinafter, also referred to as “in the malfunction indication condition”). In this context, a new condition includes the image forming apparatus 100 being entirely new and/or the heating element group 45 or a sub-device incorporating a heating element group 45 (for example, the fixing device 30) including the heating element group 45 is new. In addition, in the present context, a malfunction of the heating element group 45 is considered to indicate a disconnection caused by fracture of the heating element group 45, for example.

In FIGS. 11 and 12, the vertical axis represents a voltage and the horizontal axis represents time. As illustrated in FIGS. 11 and 12, in both the new condition and the malfunction indication condition, the voltage fluctuates within a constant range for some period of time. In the present example, this relatively stable period in which the voltage fluctuates within a substantially constant range is set as the period in which the voltage is to be sampled (measured).

The fluctuation range for the new condition is set as a voltage fluctuation range DV0, and the fluctuation range in the malfunction indication condition is set as a voltage fluctuation range DV1. The fluctuation range DV0 is smaller than the fluctuation range DV1. In addition, when the maximum values (magnitudes) of the voltages shown in the graphs are compared to each other, the magnitude of the voltage in the new condition is less than the magnitude of the voltage in the malfunction indication condition. Accordingly, it can be seen that the possibility of the malfunction indication condition increases as the difference between the fluctuation ranges increases, or as the magnitude of the voltage becomes higher than the magnitude of the voltage in the new condition. Accordingly, the server 51 is configured to determine whether there is an indication of a malfunction in the image forming apparatus 100 based on the characteristics that the possibility of a malfunction indication condition increases either as the difference between the fluctuation ranges increases or as the voltage level becomes higher than the voltage level in the new condition.

Next, aspects of the voltage information will be described. Both the reference voltage information and the operating voltage information are data obtained by sampling the voltage detected by the power supply voltage detection circuit 201. In the following description, the period when the voltage is sampled will also be referred to as “sampling period”. In the example embodiment, the sampling period is 10 seconds.

The reference voltage information is data obtained by sampling the voltage detected by the power supply voltage detection circuit 201 at a sampling frequency of 600 Hz when the heating element group 45 is in the new condition. The operating voltage information is data obtained by sampling the voltage detected by the power supply voltage detection circuit 201 at a sampling frequency of 600 Hz after the use of the image forming apparatus 100 begins after the new condition measurements.

Accordingly, in the present example, both the reference voltage information and the operating voltage information each include 6000 different measured voltage values. When the number of quantization bits is 16 bits, then both the reference voltage information and the operating voltage information are data of approximately 12 kilobytes.

Furthermore, as illustrated in FIG. 11, the voltages included in the reference voltage information do not include the initial voltages detected when the image forming apparatus 100 starts up or when the image forming apparatus 100 returns from the idle state. Likewise, as illustrated in FIG. 12, the voltages included in the operating voltage information do not include the voltages detected when the image forming apparatus 100 starts up or when the image forming apparatus 100 returns from the idle state. The reason for this exclusion of initial data is that the voltage temporarily decreases significantly during the start-up or during the return from idling. If these exceptional transient voltages are included, the server 51 may not be able to make an appropriate determination.

The reference voltage information acquisition unit 511 of the server 51 acquires the reference voltage information from the image forming apparatus 100. The reference voltage information is then stored in the reference voltage information storage unit 512. The reference voltage information can be stored until the heating element group 45 is renewed by replacement or the like.

The operating voltage information acquisition unit 513 acquires the operating voltage information from the image forming apparatus 100. Regarding the acquisition timing for this information, in the present embodiment, since the image forming apparatus 100 transmits the operating voltage information whenever the image forming apparatus 100 starts up, the transmission timing becomes the acquisition timing. The operating voltage information to be transmitted at this time is the operating voltage information acquired in a stable state, as illustrated in FIG. 12, where the voltage fluctuates in is in substantially constant fluctuation range after the start-up. However, in some examples, the image forming apparatus 100 may transmit the operating voltage information to the server 51 on a regularized basis (for example, once a week, or the like). Furthermore, in addition to regular transmissions, the image forming apparatus 100 may transmit the operating voltage information when there is clearly an abnormality or a certain operating precondition has been met.

The derivation unit 514 derives the reference voltage, the reference fluctuation range, the operating voltage, and the operating fluctuation range. An example of a derivation method will be described. In this example, both the reference voltage and the operating voltage are derived using the same derivation method. Specifically, the reference voltage is taken as the maximum value among the 6000 voltages in the reference voltage information. Likewise, the operating voltage is taken as the maximum value among the 6000 voltages in the operating voltage information. The reference fluctuation range is a value obtained by subtracting the minimum value from the maximum value among the 6000 voltages in the reference voltage information. The operating fluctuation range is a value obtained by subtracting the minimum value from the maximum value among the 6000 voltages in the operating voltage information.

The reference voltage and the reference fluctuation range derived as described above are then stored in the reference voltage information storage unit 512. In addition, the operating voltage and the operating fluctuation range can be derived whenever the operating voltage information is acquired by the operating voltage information acquisition unit 513.

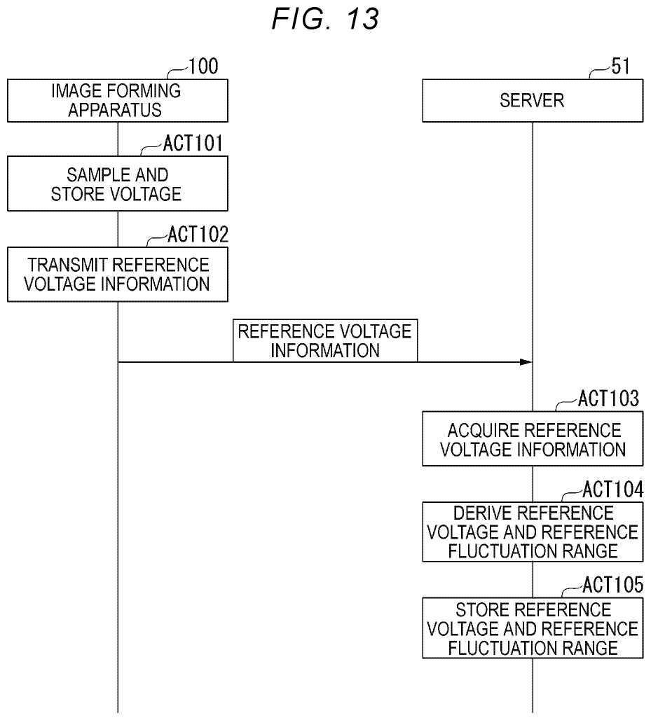

Next, processes of the image forming apparatus 100 and the server 51 will be described using a sequence diagram or a flowchart. FIG. 13 is a sequence diagram illustrating a process relating to the reference voltage information. The image forming apparatus 100 samples the voltage detected by the power supply voltage detection circuit 201 at a sampling frequency of 600 Hz in the new condition (ACT 101). The image forming apparatus 100 stores the reference voltage information obtained by sampling, and transmits the stored reference voltage information to the server (ACT 102). At this time, the image forming apparatus 100 transmits the reference voltage information including information indicating that the content of transmission is reference voltage information along with identification information for uniquely identifying the particular image forming apparatus 100 providing the reference voltage information.

The server 51 acquires the reference voltage information (ACT 103). The derivation unit 514 derives the reference voltage and the reference fluctuation range from the reference voltage information as described or otherwise (ACT 104). The derived reference voltage and the reference fluctuation range are stored in the reference voltage information storage unit 512 in association with the identification information (ACT 105).

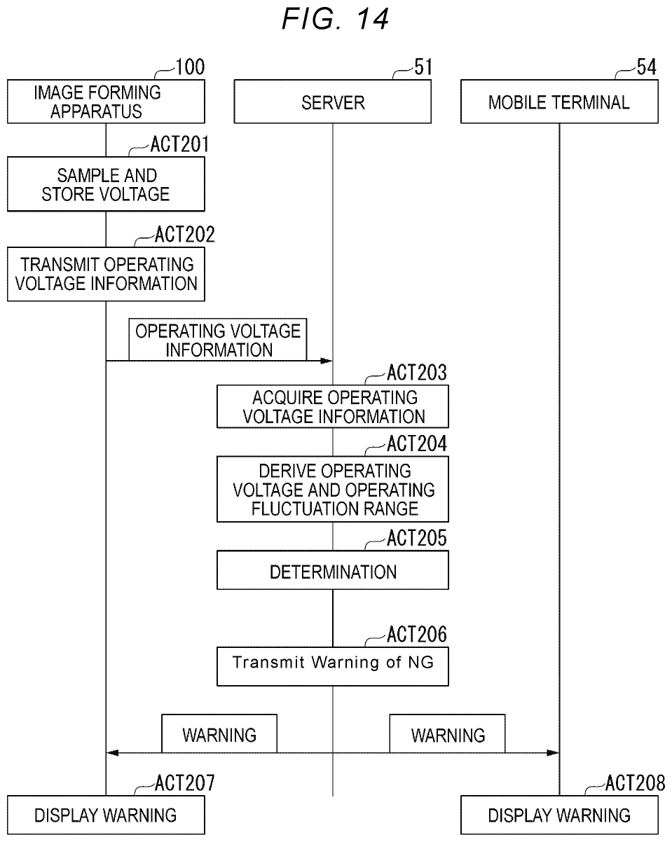

FIG. 14 is a sequence diagram illustrating a process relating to the operating voltage information. The image forming apparatus 100 samples the voltage detected by the power supply voltage detection circuit 201 at a sampling frequency of 600 Hz when the transmission trigger of the operating voltage information arrives (ACT 201). The image forming apparatus 100 stores the operating voltage information obtained by sampling, and transmits the stored operating voltage information to the server 51 (ACT 202). The image forming apparatus 100 transmits the operating voltage information along with information indicating that the content of transmission is operating voltage information and identification information for uniquely identifying the particular image forming apparatus 100 providing the operating voltage information.

The server 51 acquires the operating voltage information (ACT 203). The derivation unit 514 then derives the operating voltage and the operating fluctuation range from the operating voltage information as described or otherwise (ACT 204). The determination unit 515 determines whether there is an indication of a malfunction in the heat generation unit using the derived operating voltage and the operating fluctuation range and previously derived reference voltage and the reference fluctuation range stored in the reference voltage information storage unit 512 in association with the identification information (ACT 205).

When the determination result is “OK,” the image forming apparatus 100 ends the process relating to the operating voltage information. When the determination result is “OK,” the image forming apparatus 100 no warning is sent in ACT 206, but a message indicating the successfully determined status may be sent. FIG. 14 illustrates a process of sending a warning to at least one of the image forming apparatus 100 and the mobile terminal 54 when the determination result is “NG” (not good). The image forming apparatus 100 that receives the warning may display a warning message on the display 1 that there is an indication of a malfunction in the heat generation unit (ACT 207). Likewise, the mobile terminal 54 may display a warning message that there is an indication of a malfunction in the heat generation unit on a screen of the mobile terminal 54 (ACT 208).

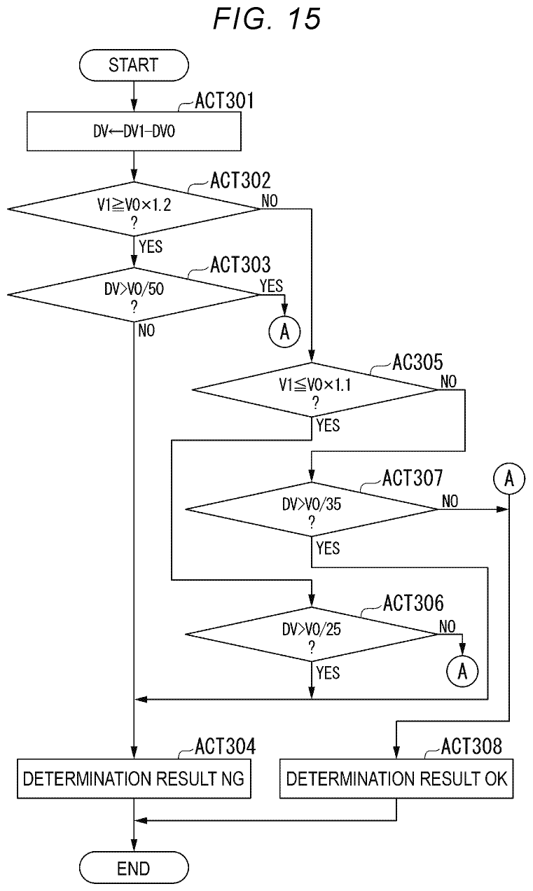

FIG. 15 is a flowchart illustrating a determination process for the determination unit 515. First, various parameters used in the determination process of FIG. 15 will be described. The parameter “V0” represents the reference voltage. The parameter “V1” represents the operating voltage. The parameter “DV0” represents the reference fluctuation range. The parameter “DV1” represents the operating fluctuation range.

The determination unit 515 subtracts DV0 from DV1 to calculate the difference DV (ACT 301). The determination unit 515 next determines whether the operating voltage V1 is at least 1.2 times greater than the reference voltage V0 (ACT 302). When the operating voltage V1 is at least 1.2 times greater than the reference voltage V0 (ACT 302: YES), the determination unit 515 next determines whether the difference DV is greater than 1/50 (one fiftieth) of the reference voltage V0 (ACT 303). When the difference DV is greater than ⅕ of the reference voltage V0 (ACT 303: YES), the determination unit 515 determines that the determination result is “NG” (ACT 304) and ends the process. When the difference DV is less than or equal to 1/50 of the reference voltage V0 (ACT 303: NO), the determination unit 515 determines that the determination result is “OK” (ACT 308) and ends the process.

When the operating voltage V1 is less than 1.2 times the reference voltage V0 (ACT 302: NO) in ACT 302, the determination unit 515 next determines whether the operating voltage V1 is 1.1 times or less than the reference voltage V0 (ACT 305). When the operating voltage V1 is 1.1 times or less the reference voltage V0 (ACT 305: YES), the determination unit 515 determines whether the difference DV is more than 1/25 of the reference voltage V0 (ACT 306). When the difference DV is more than 1/25 (one twenty-fifth) of the reference voltage V0 (ACT 306: YES), the determination unit 515 determines that the determination result is “NG” (ACT 304) and ends the process. On the other hand, when the difference DV is less than or equal to 1/25 of the reference voltage V0 (ACT 306: NO), the determination unit 515 determines that the determination result is “OK” (ACT 308) and ends the process.

When the operating voltage V1 is greater than 1.1 times the reference voltage V0 (ACT 305: NO) in ACT 305, the operating voltage V1 is more than 1.1 times the reference voltage V0 but is less than 1.2 times the reference voltage V0. In this case, the determination unit 515 determines whether the difference DV is greater than 1/35 (one thirty-fifth) of the reference voltage V0 (ACT 307). When the difference DV is greater than 1/35 of the reference voltage V0 (ACT 307: YES), the determination unit 515 determines that the determination result is “NG” (ACT 304) and ends the process. On the other hand, when the difference DV is less than or equal to 1/35 of the reference voltage V0 (ACT 306: NO), the determination unit 515 determines that the determination result is “OK” (ACT 308) and ends the process.

As illustrated in the flowchart of FIG. 15, as the operating voltage becomes higher than the reference voltage, the determination result is more likely to be determined as “NG” even though the difference DV between the fluctuation ranges remains small. In addition, even if the operating voltage and the reference voltage are almost the same, the determination result is still likely to be “NG” when the difference DV between the fluctuation ranges becomes large. Accordingly, it can be seen that the determination result is more likely to be set to “NG” when the operating voltage becomes higher than the reference voltage or when the difference DV between the fluctuation ranges increases.

This is a characteristic when there is an indication of a potential malfunction as described with FIGS. 11 and 12. Accordingly, the server 51 and the system 50 according to an embodiment can more accurately determine whether or not there is an indication of a malfunction in a heating element or device. In addition, by sending a warning of a malfunction indication, the occurrences of an actual malfunction can be avoided.

In an example embodiment, whether there is an indication of a malfunction in a heating element or device is determined using the operating voltage, the reference voltage, the reference fluctuation range, and the operating fluctuation range. However, in other examples, such a determination may be made using only the reference fluctuation range and the operating fluctuation range. This is possible because a significant difference between the reference fluctuation range and the operating fluctuation range can be confirmed as illustrated in FIGS. 11 and 12. Even in this case, whether there is an indication of a malfunction in the heating member can be still accurately determined.

In an example embodiment, the sampling period was set as 10 seconds. However, the sampling period in other examples may be 1 to 10 seconds in length. In addition, in an example, embodiment the sampling frequency was set as 600 Hz, but is not limited thereto. In general, any frequency can be used as long as it is a sampling frequency at which the voltage can be sampled at a frequency exceeding two times the maximum frequency of the waveform of the voltage.

In an example embodiment, the voltages included in the reference voltage information and/or the operating voltage information exclude the voltages detected at the time of start-up or return. In other examples, the reference voltage information and/or the operating voltage information may exclude voltages detected when the power supply to the heating element group 45 begins or when the press roller 302 is still approaching the fixing unit 301.

In an example embodiment, the heating element group 45 is formed of a TCR material. However, the present disclosure is also applicable to a case where heat is generated by induction heating or by a halogen heater.

In an example embodiment, a single server 51 determines whether there is an indication of a malfunction. However, the indication of a malfunction may instead, or in addition, be determined by online, virtualized, and/or “cloud-based” devices and/or systems such as provided as Infrastructure as a Service (“IaaS”) type computing systems.

Each of the functions of the image forming apparatus in the embodiment may be implemented by a computer. In this case, a program for implementing a function may be recorded in a non-transitory computer-readable recording medium. Such a recorded program may be read from the recording medium and executed by the computer or computer system. In general, a “computer system” described herein may include an operating system (OS) and additional hardware such as a peripheral devices. In present context, a “non-transitory computer-readable recording medium” refers to a storage device, for example, a portable medium such as a flexible disk, a magneto-optical disk, a ROM, a CD-ROM, a hard disk built into a computer system, a server or other storage device a recording medium accessible via a communication line or network such as the Internet. In addition, the program may be a program that can realize one or more of the above-described functions by combination with another program recorded in a computer system.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such embodiments or modifications as would fall within the scope and spirit of the invention.

What is claimed is:

1. An information processing apparatus, comprising:
a storage unit;
a processor configured to:
acquire voltage information for an image forming apparatus, the voltage information indicating voltages applied to a heat generation unit of the image forming apparatus for heating a sheet in the image forming apparatus,
calculate a fluctuation range for the voltages in the voltage information, and
detect whether there is an indication of a malfunction in the heat generation unit based on at least a comparison of the calculated fluctuation range and a reference fluctuation range stored in the storage unit.

2. The information processing apparatus according to claim 1, wherein the detection of the indication of a malfunction in the heat generation unit is additionally based on a comparison of a maximum voltage level in the voltage information and a reference voltage level stored in the storage unit.

3. The information processing apparatus according to claim 1, wherein the voltage information excludes voltages detected during a startup period of the heat generating unit.

4. The information processing apparatus according to claim 1, wherein the startup period is a return after a device idle state.

5. The information processing apparatus according to claim 1, wherein the processor is further configured to cause a warning message to be transmitted when there is an indication of a malfunction in the heat generation unit.

6. The information processing apparatus according to claim 5, wherein the warning message is transmitted via a network connection to the image forming apparatus.

7. The information processing apparatus according to claim 5, wherein the warning message is transmitted via a network connection to a mobile terminal associated with the image forming apparatus in the storage unit.

8. The information processing apparatus according to claim 1, wherein the processor is further configured to cause the reference information to be stored in the storage unit when the reference information is received from the image forming apparatus.

9. The information processing apparatus according to claim 1, wherein a plurality of image forming apparatus are connected to the information processing apparatus via a network.

10. An information processing system for managing image forming apparatuses, the system comprising:
an information processing apparatus including a processor and a first storage unit; and
an image forming apparatus including:
a heater to heat a sheet in an image forming operation,
a second storage unit configured to store voltage information indicating voltages applied to the heater during a period of time after a startup period, and
a communication interface configured to transmit the voltage information to the information processing apparatus, wherein
the processor of the information processing apparatus is configured to:
acquire the voltage information from the image forming apparatus,
calculate a fluctuation range for the voltages in the voltage information, and
detect whether there is an indication of a malfunction in the heater based on at least a comparison of the calculated fluctuation range and a reference fluctuation range stored in the first storage unit.

11. The information processing system according to claim 10, wherein the detection of the indication of a malfunction in the heater is additionally based on a comparison of a maximum voltage level in the voltage information and a reference voltage level stored in the first storage unit.

12. The information processing system according to claim 10, wherein the voltage information excludes voltages detected during the startup period.

13. The information processing system according to claim 10, wherein the startup period is a return after a device idle state.

14. The information processing system according to claim 10, wherein the processor is further configured to cause a warning message to be transmitted when there is an indication of a malfunction in the heat generation unit.

15. The information processing system according to claim 14, wherein the warning message is transmitted via a network connection to the image forming apparatus.

16. The information processing system according to claim 10, wherein the warning message is transmitted via a network connection to a mobile terminal associated with the image forming apparatus in the first storage unit.

17. The information processing system according to claim 10, wherein the processor is further configured to cause the reference information to be stored in the first storage unit when the reference information is received from the image forming apparatus.

18. The information processing system according to claim 10, further comprising:
a plurality of image forming apparatus connected to the information processing apparatus via a network.

19. A non-transitory computer-readable storage medium storing program instructions which when executed by a processor of an information processing apparatus causes the information processing apparatus to perform a method comprising:
acquiring voltage information for an image forming apparatus, the voltage information indicating voltages applied to a heat generation unit of the image forming apparatus for heating a sheet in the image forming apparatus;
calculating a fluctuation range for the voltages in the voltage information; and detecting whether there is an indication of a malfunction in the heat generation unit based on at least a comparison of the calculated fluctuation range and a reference fluctuation range stored in the storage unit.

20. The non-transitory computer-readable storage medium according to claim 19, wherein the detecting of the indication of a malfunction in the heat generation unit is additionally based on a comparison of a maximum voltage level in the voltage information and a reference voltage level stored in the storage unit.
